(19) United States
(12) Patent Application Publication
(10) Pub. No.: US 2011/0128411 A1
(43) Pub. Date: Jun. 2, 2011

(54) IMAGE CAPTURING APPARATUS AND IMAGE CAPTURING METHOD

(76) Inventors: AKIHIRO MASUBUCHI, KANAGAWA (JP); TAKAYOSHI KAWAGUCHI, KANAGAWA (JP)

(21) Appl. No.: 12/952,458

(22) Filed: Nov. 23, 2010

(30) Foreign Application Priority Data
Dec. 1, 2009 (JP) P2009-273819

(51) Int. Cl. H04N 5/76; H04N 7/12

(52) U.S. Cl. 348/231.99; 375/240.25; 348/E05.031; 375/E07.027

(57) ABSTRACT

There is provided an image capturing device including a compression unit for lossless-compressing a video signal outputted from an imaging element, a storage unit for accumulating the video signal that is compressed, a decompression unit for decompressing the video signal that is compressed and accumulated in the storage unit, and a combining unit for combining a plurality of frame images based on the decompressed video signal into one frame image.

### BACKGROUND OF THE INVENTION

1. Field of the Invention

The present invention relates to an image capturing apparatus and an image capturing method.

2. Description of the Related Art

In image capturing using an image capturing device such as a digital still camera and a video camera, usually, exposure is controlled and adjusted in accordance with environment light so that captured images are easily viewable by a user. However, if there is an area partially brighter or darker than other areas in an image, an overexposed area or an underexposed area may readily be formed. Therefore, in an image capturing device using an imaging element such as a CCD image sensor or a CMOS image sensor, to widen dynamic range, there is a technique in which a plurality of frame images are captured with a plurality of different exposure times and the images are combined. Techniques for widening dynamic range are also disclosed in Japanese Patent Application Laid-Open Nos. 2007-151069, 2007-214832, 2008-099158, 2008-227697, 2008-271280, and 2008-294698.

### SUMMARY OF THE INVENTION

A video image whose dynamic range is widened (hereinafter also referred to as “wide dynamic range video image”) is obtained by capturing a plurality of images, so that an amount of data used for capturing one wide dynamic range video image is greater than that of a normal image. A frame memory is used to combine a plurality of images, so that circuit load increases. Further, when a wide frequency range image is written to or read from a memory, or outputted to outside, a wide frequency band is used.

On the other hand, a wide range dynamic image is desired to be transmitted in real time in an image capturing device. The issues described above become more obvious as image quality improves and image resolution increases.

In light of the foregoing, it is desirable to provide a novel and improved image capturing apparatus and image capturing method capable of quickly transmitting a wide dynamic range video image combined and generated from a plurality of images and reducing frequency band to reduce circuit load.

According to an embodiment of the present invention, there is provided an image capturing device including a compression unit for lossless-compressing a video signal outputted from an imaging element, a storage unit for accumulating the video signal that is compressed, a decompression unit for decompressing the video signal that is compressed and accumulated in the storage unit, and a combining unit for combining a plurality of frame images based on the decompressed video signal into one frame image.

The compression unit may lossless-compress the video signal that is outputted from the imaging element and has not been lossy-compressed yet.

The compression unit may lossless-compress the video signal on the basis of difference information between a pixel value of a pixel of interest and a pixel value of another pixel in the video signal and the number of bits that represent the difference information.

The number of the decompression units may be the same as the number of a plurality of frame images that are combined by the combining unit.

According to another embodiment of the present invention, there is provided an image capturing device including a compression unit for lossless-compressing a video signal which is outputted from an imaging element and in which a plurality of frame images are combined into one frame image, a storage unit for accumulating the video signal that is compressed, and a decompression unit for decompressing the video signal that is compressed and accumulated in the storage unit and outputting the decompressed video signal to an image processing unit for image-processing a current video signal.

The compression unit may lossless-compress the video signal that is outputted from the imaging element and has not been lossy-compressed yet.

The video signal that is compressed by the compression unit may be floating-point format.

The compression unit may divide the floating-point format video signal into an exponent part and a mantissa part and may compress the exponent part and the mantissa part individually.

The compression unit may lossless-compress the video signal on the basis of comparison information between an exponent part of a pixel value of a pixel of interest and an exponent part of a pixel value of another pixel in the video signal and the number of bits that represent an exponent part of the pixel value of the pixel of interest.

The compression unit may lossless-compress the video signal on the basis of difference information between a mantissa part of a pixel value of a pixel of interest and a mantissa part of a pixel value of another pixel in the video signal and the number of bits that represent the difference information.

According to another embodiment of the present invention, there is provided an image capturing method, including the steps of lossless-compressing a video signal outputted from an imaging element by using a compression unit, accumulating the compressed video signal by using a storage unit, decompressing the video signal that is compressed and accumulated in the storage unit by using a decompression unit, and combining a plurality of frame images based on the decompressed video signal into one frame image by using a combining unit.

According to another embodiment of the present invention, there is provided an image capturing method, including the steps of lossless-compressing a video signal which is outputted from an imaging element and in which a plurality of frame images are combined into one frame image by using a compression unit, accumulating the compressed video signal by using a storage unit, and decompressing the video signal that is compressed and accumulated in the storage unit and outputting the decompressed video signal to an image processing unit for image-processing a current video signal by using a decompression unit.

As described above, according to an embodiment of the present invention, it is possible to quickly transmit a wide dynamic range video image combined and generated from a plurality of images and reduce frequency band to reduce circuit load.

### BRIEF DESCRIPTION OF THE DRAWINGS

FIG. 1 is a block diagram showing an image capturing device 100 according to an embodiment of the present invention;

FIG. 2 is a block diagram showing a wide dynamic range video image combining unit 110 according to the embodiment;

FIG. 3 is a block diagram showing a wide dynamic range video image processing unit 120 according to the embodiment;

FIG. 4 is a flowchart showing compression processing of a video signal before wide dynamic range combination according to the embodiment;

FIG. 5 is a flowchart showing decompression processing of a video signal before wide dynamic range combination according to the embodiment;

FIG. 6 is a block diagram related to compression coefficient calculation processing of a video signal before wide dynamic range combination according to the embodiment;

FIG. 7 is a flowchart showing compression processing of a wide dynamic range floating-point format video signal exponent part according to the embodiment;

FIG. 8 is a flowchart showing compression processing of a wide dynamic range floating-point format video signal mantissa part according to the embodiment;

FIG. 9 is a flowchart showing decompression processing of a wide dynamic range floating-point format video signal exponent part according to the embodiment;

FIG. 10 is a flowchart showing decompression processing of a wide dynamic range floating-point format video signal mantissa part according to the embodiment;

FIG. 11 is a graph showing a compression example of a video signal before wide dynamic range combination;

FIG. 12 is a graph showing a compression example of a video signal before wide dynamic range combination;

FIG. 13 is a graph showing a compression example of a video signal before wide dynamic range combination;

FIG. 14 is a graph showing a compression example of a video signal before wide dynamic range combination;

FIG. 15 is a graph showing a compression example of a video signal before wide dynamic range combination; and

FIG. 16 is a graph showing a compression example of a video signal before wide dynamic range combination.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Configuration of an embodiment

2. Operation of an embodiment

<1. Configuration of an Embodiment>

[Image Capturing Device 100]

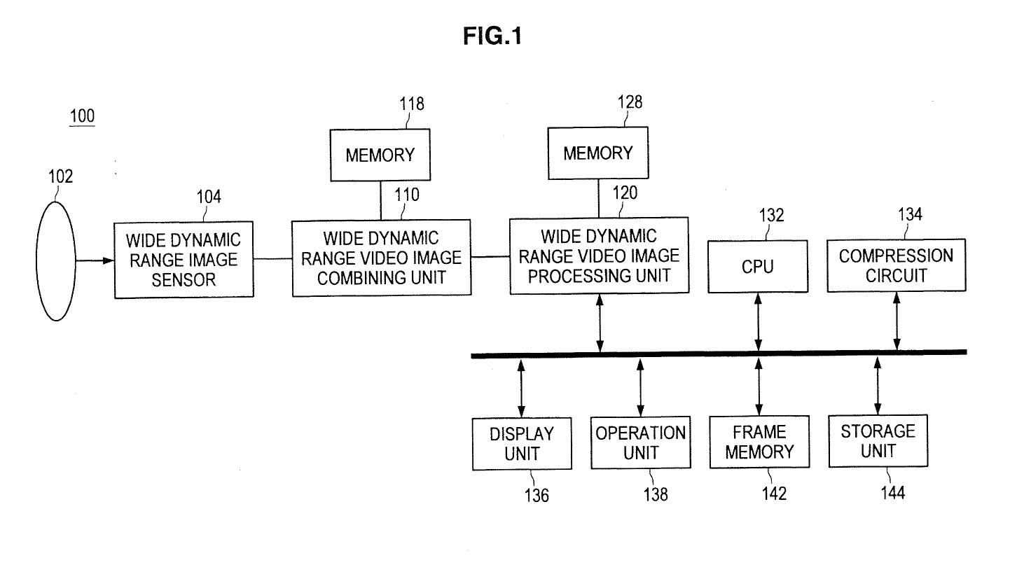

First, an image capturing device 100 according to an embodiment of the present invention will be described. FIG. 1 is a block diagram showing the image capturing device 100 according to the embodiment. The image capturing device 100 is, for example, a digital still camera or a video camera. In particular, in this embodiment, the image capturing device 100 has a wide dynamic range image capturing function capable of image capturing with widened dynamic range.

The image capturing device 100 includes, for example, an optical system 102, a wide dynamic range image sensor 104, a wide dynamic range video image combining unit 110, a memory 118, a wide dynamic range video image processing unit 120, a memory 128, a CPU 132, a compression circuit 134, a display unit 136, an operation unit 138, a frame memory 142, a storage unit 144, and so on.

The optical system 102 lets light from an object pass through, and irradiates the light onto the wide dynamic range image sensor.

The wide dynamic range image sensor 104 is, for example, a CMOS imaging element or a CCD imaging element. The wide dynamic range image sensor 104 sequentially outputs video signals. When performing wide dynamic range image capturing, the wide dynamic range image sensor 104 captures a plurality of frame images in a plurality of different exposure conditions. Thereafter, the plurality of frame images are combined in the wide dynamic range video image combining unit 110 at a later stage, so that an image whose dynamic range is widened is obtained. The wide dynamic range image sensor 104 outputs frame images at, for example, 120 fps.

The wide dynamic range video image combining unit 110 receives the video signals outputted from the wide dynamic range image sensor 104, and combines a plurality of frame images. At this time, while the wide dynamic range video image combining unit 110 compresses the video signals and writes the compressed video signals to the memory 118, the wide dynamic range video image combining unit 110 reads video signals written previously from the memory 118, performs decompression processing, and then combines the decompressed video signals. When the wide dynamic range video image combining unit 110 combines four frame images into one, the wide dynamic range video image combining unit 110 combines frame images transmitted at 120 fps and outputs combined frame images at 30 fps.

The wide dynamic range video image processing unit 120 receives a combined video signal outputted from the wide dynamic range video image combining unit 110, and performs various image processing such as noise reduction on the video signal. The wide dynamic range video signal received by the wide dynamic range video image processing unit 120 is floating-point format so as to reduce the number of bits while maintaining characteristic of wide dynamic range. While the wide dynamic range video image processing unit 120 losslessly compresses the wide dynamic range video signal having a floating-point format and writes the compressed video signal to the memory 128, the wide dynamic range video image processing unit 120 reads video signal written previously from the memory 128, and performs image processing on the read video signal along with the current video signal.

The wide dynamic range video image combining unit 110 and wide dynamic range video image processing unit 120 are, for example, an FPGA or an ASIC. The memory 118 and the memory 128 are, for example, a DDR-SD-RAM.

The CPU 132 is a control device or an arithmetic device, and for example, controls each functional block in the image capturing device 100. The CPU 132 reads a program recorded in the storage unit 144 and executes the program.

The compression circuit 134 compresses the video signal which is combined, image-processed, and outputted from the wide dynamic range video image processing unit 120 into a compressed file format such as the JPEG format or the MPEG format. Generally, the compression is a lossy compression.

The display unit 136 is a liquid crystal display, an organic EL display, or the like provided in a housing of the image capturing device 100. The display unit 136 displays an object image when capturing image and a video image after image capturing. Also, the display unit 136 displays a setting menu or the like of the image capturing device 100.

The operation unit 138 is, for example, a button provided on the housing of the image capturing device 100, a touch panel provided on the display unit 136, a remote control, and the like. The operation unit 138 generates an operation signal when receiving an operation of a user. The operation unit 138 transmits the generated operation signal to the CPU 132 and the like.

The frame memory 142 accumulates the video signal which is combined, image-processed, and outputted from the wide dynamic range video image processing unit 120. The video signal accumulated in the frame memory 142 is used for compression processing or the like in the compression circuit 134.

The storage unit 144 accumulates the compression-processed video signal as a compressed file. Also, the storage unit 144 stores the program executed by the CPU 132.

[Wide Dynamic Range Video Image Combining Unit]

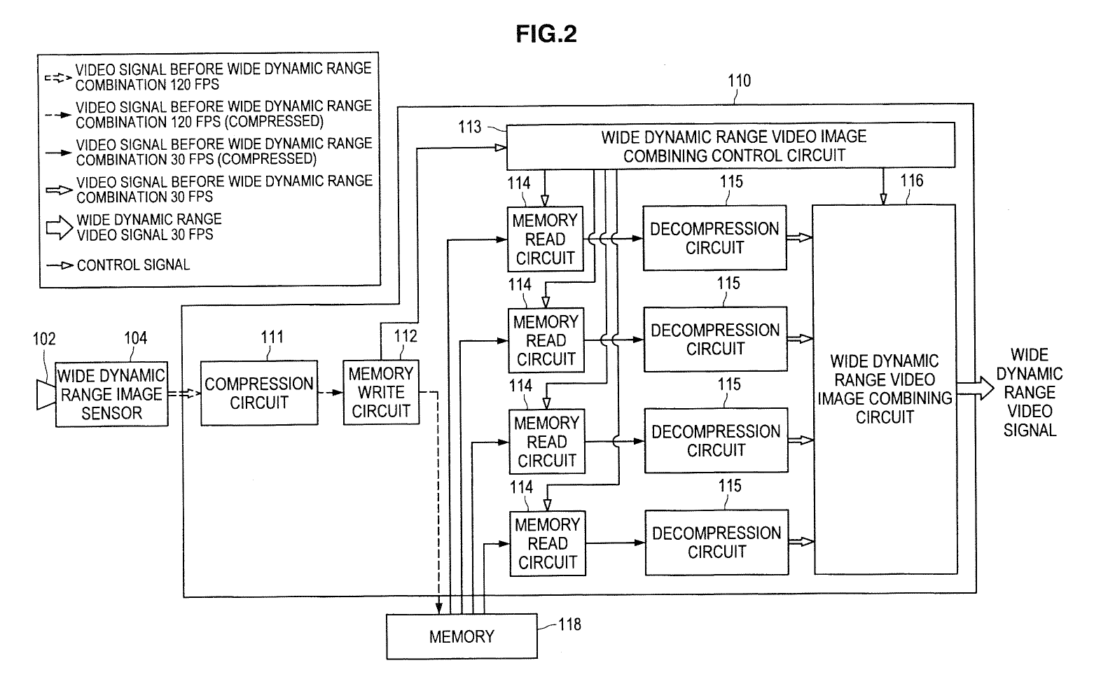

Next, the wide dynamic range video image combining unit 110 according to the embodiment will be described with reference to FIG. 2. FIG. 2 is a block diagram showing the wide dynamic range video image combining unit 110 according to the embodiment.

The wide dynamic range video image combining unit 110 includes, for example, a compression circuit 111, a memory write circuit 112, a wide dynamic range video image combining control circuit 113, a plurality of memory read circuits 114, a plurality of decompression circuits 115, a wide dynamic range video image combining circuit 116, and the like.

The compression circuit 111 losslessly compresses the video signal using a compression algorithm described below. When receiving frame images at 120 fps, the compression circuit 111 outputs compressed video signals at 120 fps.

The memory write circuit 112 writes compressed video signals to the memory 118. When receiving frame images at 120 fps, the memory write circuit 112 outputs the compressed video signals at 120 fps.

The wide dynamic range video image combining control circuit 113 receives a timing of frame from the memory write circuit. Also, the wide dynamic range video image combining control circuit 113 controls reading of video signal performed by the memory read circuit 114 on the basis of the timing of frame, and controls combining processing performed by the wide dynamic range video image combining circuit 116.

The memory read circuits 114, the number of which is the same as the number of the decompression circuits 115, are provided, and each of the memory read circuits 114 read compressed video signal written to the memory 118. When the frame images are outputted at 120 fps from the wide dynamic range image sensor 104 and there are four decompression circuits 115, the memory read circuit 114 reads compressed video signals at 30 fps.

The decompression circuits 115, the number of which is the same as the number of a plurality of frames combined by the wide dynamic range video image combining circuit 116, are provided. When four frame images are combined into one combined frame, four decompression circuits 115 are provided. The decompression circuits 115 decompress compressed video signal read from the memory 118. When the frame images are outputted at 120 fps from the wide dynamic range image sensor 104 and there are four decompression circuits 115, the decompression circuits 115 outputs decompressed video signals at 30 fps.

The wide dynamic range video image combining circuit 116 combines a plurality of frame images based on the decompressed video signals into one frame image. The combined frame image is a wide dynamic range image. The wide dynamic range video image combining circuit 116 outputs the combined wide dynamic range video signal to the wide dynamic range video image processing unit 120. The number of bits of each pixel of the combined wide dynamic range video signal is greater than the number of bits of each pixel outputted from the wide dynamic range image sensor 104. Therefore, the wide dynamic range video signal is a floating-point format.

[Wide Dynamic Range Video Image Processing Unit 120]

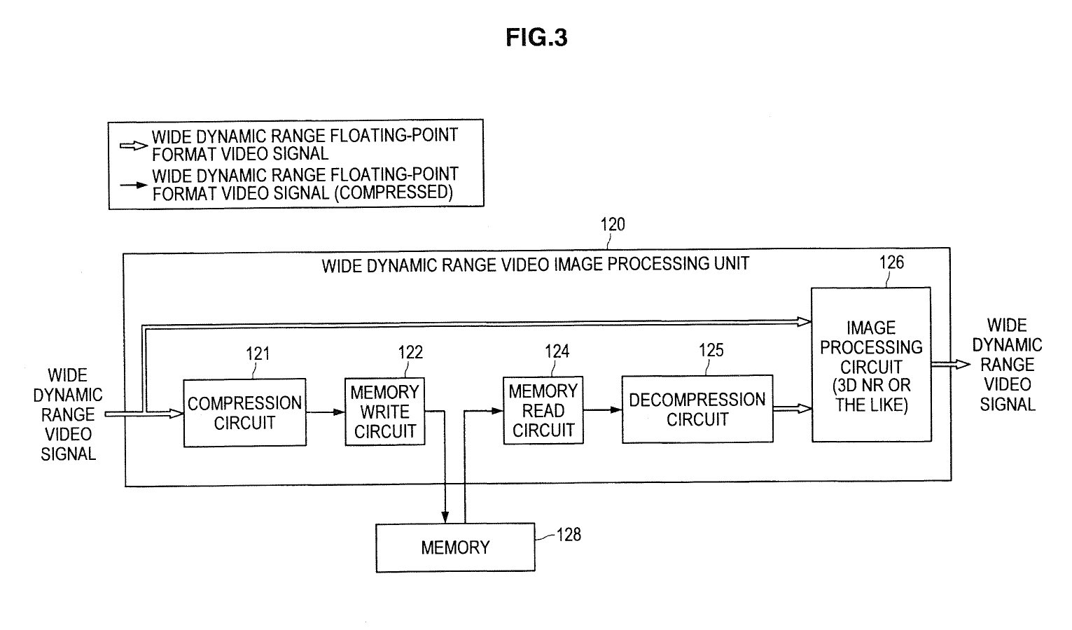

Next, the wide dynamic range video image processing unit 120 according to the embodiment will be described with reference to FIG. 3. FIG. 3 is a block diagram showing the wide dynamic range video image processing unit 120 according to the embodiment.

The wide dynamic range video image processing unit 120 includes, for example, a compression circuit 121, a memory write circuit 122, a memory read circuit 124, a decompression circuit 125, an image processing circuit 126, and the like.

The compression circuit 121 losslessly compresses the wide dynamic range video signal having a floating-point format using a compression algorithm described below. The compression circuit 121 divides the wide dynamic range video signal having a floating-point format into the exponent part and the mantissa part and compresses the exponent part and the mantissa part individually.

The memory write circuit 122 writes the compressed video signal to the memory 128. The memory read circuit 124 reads the compressed video signal written to the memory 128. The decompression circuit 125 decompresses the compressed video signal read from the memory 128.

The image processing circuit 126 receives the decompressed previous video signal and image-processes the current video signal. The image processing circuit 126 performs image processing such as three-dimensional noise reduction processing. The image processing circuit 126 processes the wide dynamic range video signal having a floating-point format.

<2. Operation of an Embodiment>

[Compression Processing of Video Signal Before Wide Dynamic Range Combination]

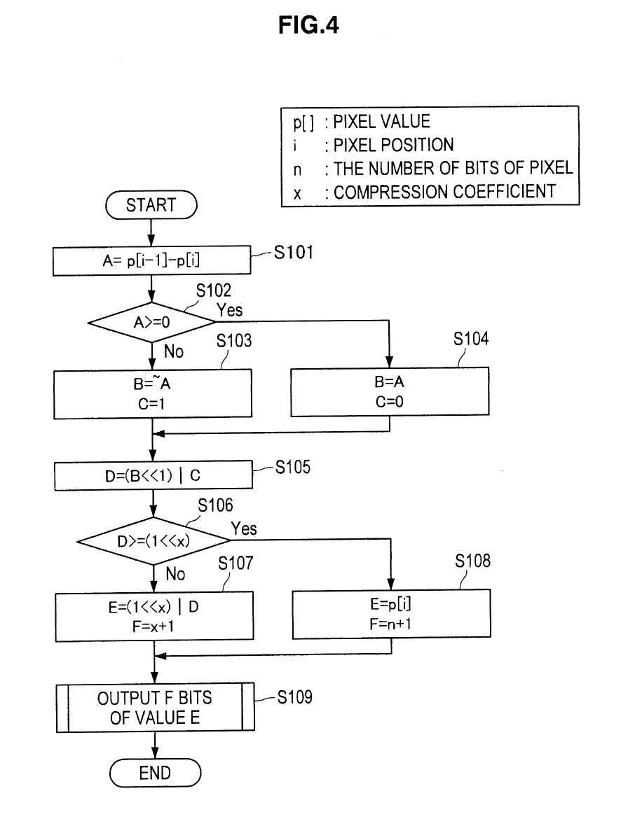

Next, compression processing of a video signal before wide dynamic range combination in the compression circuit 111 will be described with reference to FIG. 4. FIG. 4 is a flowchart showing the compression processing of the video signal before wide dynamic range combination according to the embodiment.

First, pixel value difference information D between a pixel of interest p[i] and the previous pixel p[i−1] is obtained (steps S101 to S105). “A” in step S101 is a pixel value difference between the pixel of interest p[i] and the previous pixel p[i−1]. When A is smaller than 0 (step S102), B is determined to be bit-reversed A (“˜A” represents bit-reversed A), and C is determined to be 1 (step S103). When A is greater than or equal to 0 (step S102), B is determined to be A, and C is determined to be 0 (step S104). Then, the difference information D is formed by left shifting B by 1 bit and adding C to the rightmost position. When the difference information D can be represented by x bits or less (step S106), a value E obtained by adding flag information to the difference information D is outputted (steps S107 and S109). On the other hand, when the difference information D cannot be represented by x bits or less, a value E obtained by adding flag information to the pixel value p[i] is outputted (steps S108 and S109).

Here, the pixel value p[ ] represents different things depending on the input video signal. For example, when the input video signal is still Bayer arrangement, two compression circuits 111 are prepared and each system is individually processed as p[ ]. When the input video signal is RGB, three compression circuits are prepared and each of the R, G, and B is individually processed as p[ ].

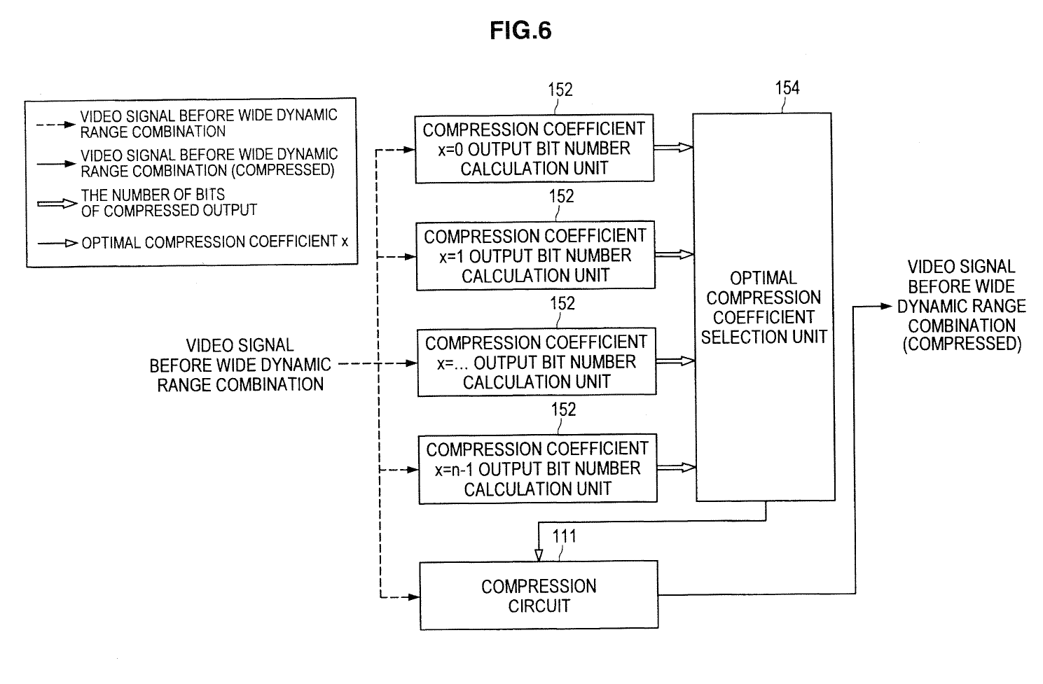

As shown in FIG. 6, as a compression coefficient x, a value showing the best compression rate in the previous frame is used because generally there is high correlation between video frames in the time direction. FIG. 6 is a block diagram related to compression coefficient calculation processing of the video signal before wide dynamic range combination according to the embodiment.

A compression coefficient x output bit number calculation unit 152 is provided for each compression coefficient x, and calculates the number of compressed output bits. An optimal compression coefficient selection unit 154 outputs the number of compressed output bits that shows the best compression rate in the previous frame, and the compression coefficient x is used for the next frame.

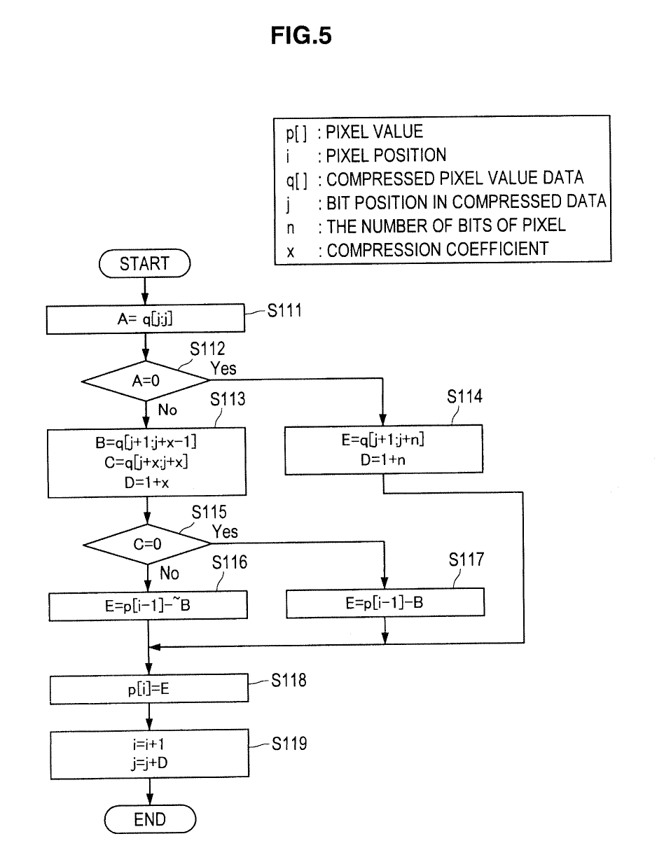

FIG. 5 is a flowchart showing the decompression processing of the video signal before wide dynamic range combination according to the embodiment. FIG. 5 shows processing for decompressing the video signal compressed by the compression processing of FIG. 4. In FIG. 5, q[j:j] represents one bit of jth bit of compressed data, and q[j+1:j+3] represents three bits from (j+1)th bit to (j+3)th bit of the compressed data. “˜B” represents bit-reversed B.

In this embodiment, the compression circuit 111 is simple, so that the scale of the circuit does not increase so much even when a plurality of compression circuits having different compression coefficient x are simply arranged. If the scale of the circuit is desired to be decreased, a fixed constant value may be used for the compression coefficient x. Although not written in the flowchart of FIG. 4, the compression coefficient x is outputted in the first part of the frame.

As a modified form of this compression algorithm, p[i−1] in the calculation A=p[i−1]−p[1] in FIG. 4 may be replaced by an average value of all pixels in the previous line to perform calculation. Or, p[i−1] may be replaced by an average value of several previous pixels or an average value of neighboring pixels to perform calculation.

[Compression Processing of Wide Dynamic Range Floating-Point Format Video Signal Exponent Part]

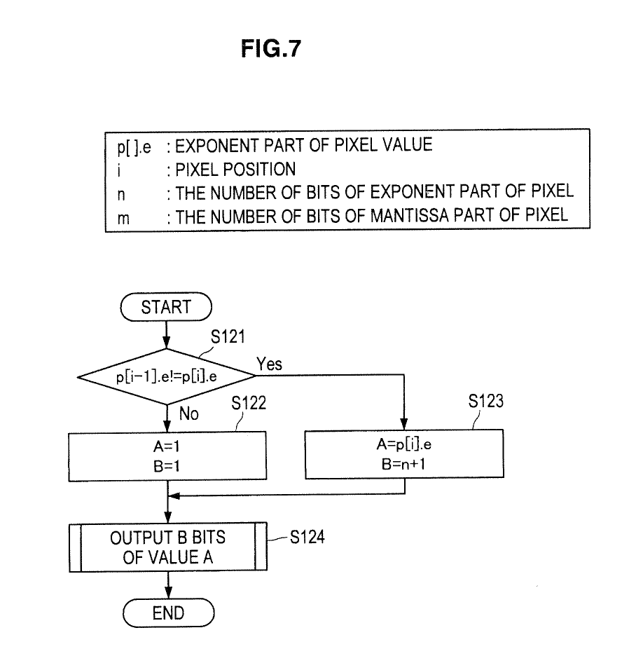

Next, compression processing of a wide dynamic range floating-point format video signal exponent part in the compression circuit 121 will be described with reference to FIG. 7. FIG. 7 is a flowchart showing the compression processing of the wide dynamic range floating-point format video signal exponent part according to the embodiment.

A pixel value exponent part p[i].e of the pixel of interest and a pixel value exponent part p[i−1].e of the previous pixel are compared, and when p[i−1].e is the same as p[i].e (step S121) (“!=” indicates that the left value and the right value are not the same), a flag 1 is outputted (steps S122 and S124). When p[i−1].e is not the same as p[i].e (step S121), a value A obtained by adding flag information to p[i].e is outputted (steps S123 and S124).

As a modified form of this compression algorithm, p[i−1].e in the determination of p[i−1].e !=p[i].e in FIG. 7 may be replaced by an average value of all pixels in the previous line to perform calculation. Or, p[i−1].e may be replaced by an average value of several previous pixels or an average value of neighboring pixels to perform calculation.

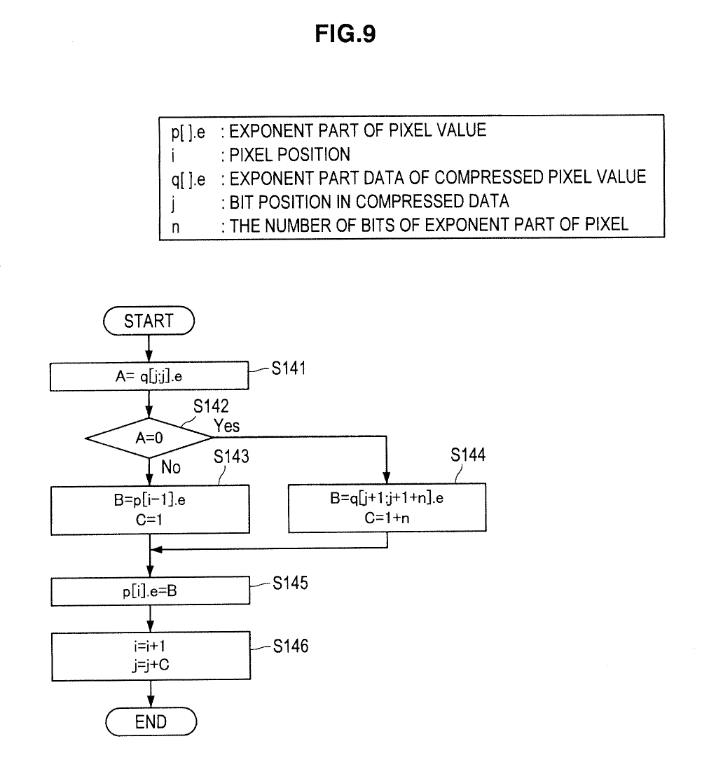

FIG. 9 is a flowchart showing the decompression processing of the wide dynamic range floating-point format video signal exponent part according to the embodiment. FIG. 9 shows processing for decompressing the video signal compressed by the compression processing of FIG. 7. In FIG. 9, q[j:j] represents one bit of jth bit of compressed data, and q[j+1:j+3] represents three bits from (j+1)th bit to (j+3)th bit of the compressed data.

[Compression Processing of Wide Dynamic Range Floating-Point Format Video Signal Mantissa Part]

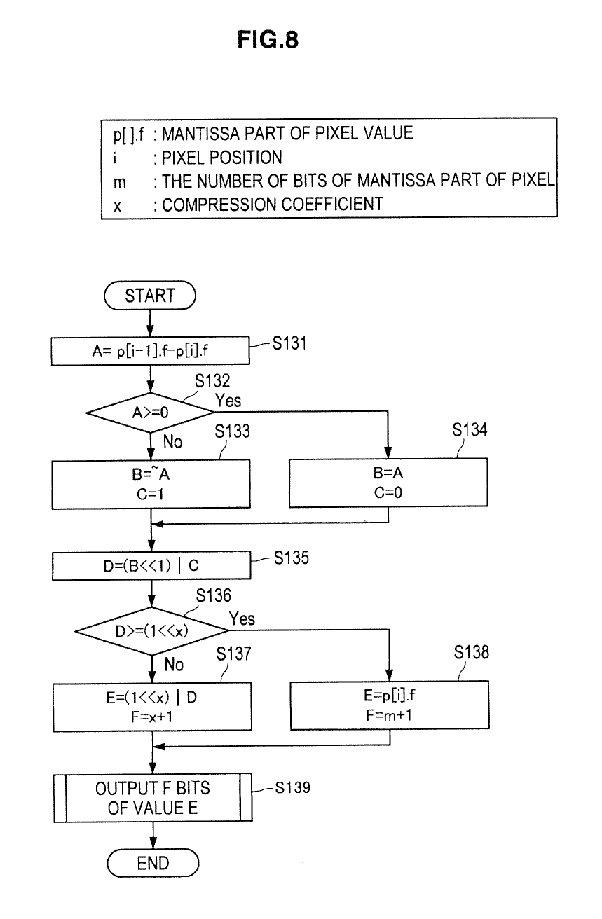

FIG. 8 is a flowchart showing the compression processing of the wide dynamic range floating-point format video signal mantissa part according to the embodiment. The compression processing of the wide dynamic range floating-point format video signal mantissa part is the same as the algorithm of the compression processing of the video signal before wide dynamic range combination shown in FIG. 4. Modified forms of the compression algorithm are the same as in the case of the video signal before wide dynamic range combination.

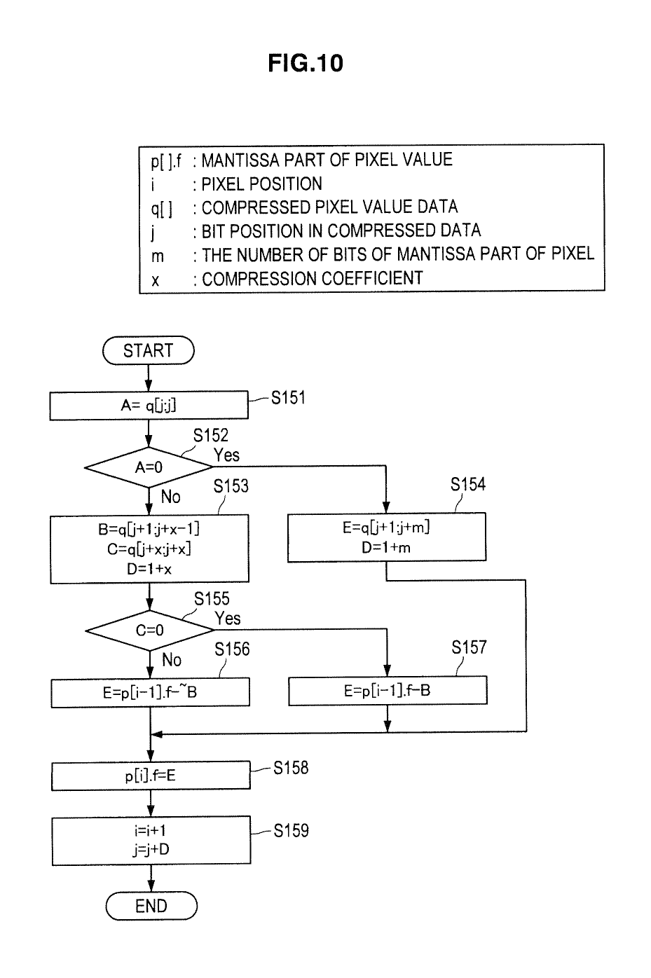

FIG. 10 is a flowchart showing the decompression processing of the wide dynamic range floating-point format video signal mantissa part according to the embodiment. FIG. 10 shows processing for decompressing the video signal compressed by the compression processing of FIG. 8. In FIG. 10, q[j:j] represents one bit of jth bit of compressed data, and q[j+1:j+3] represents three bits from (j+1)th bit to (j+3)th bit of the compressed data. “˜B” represents bit-reversed B.

<3. Compression Example of Video Signal Before Wide Dynamic Range Combination>

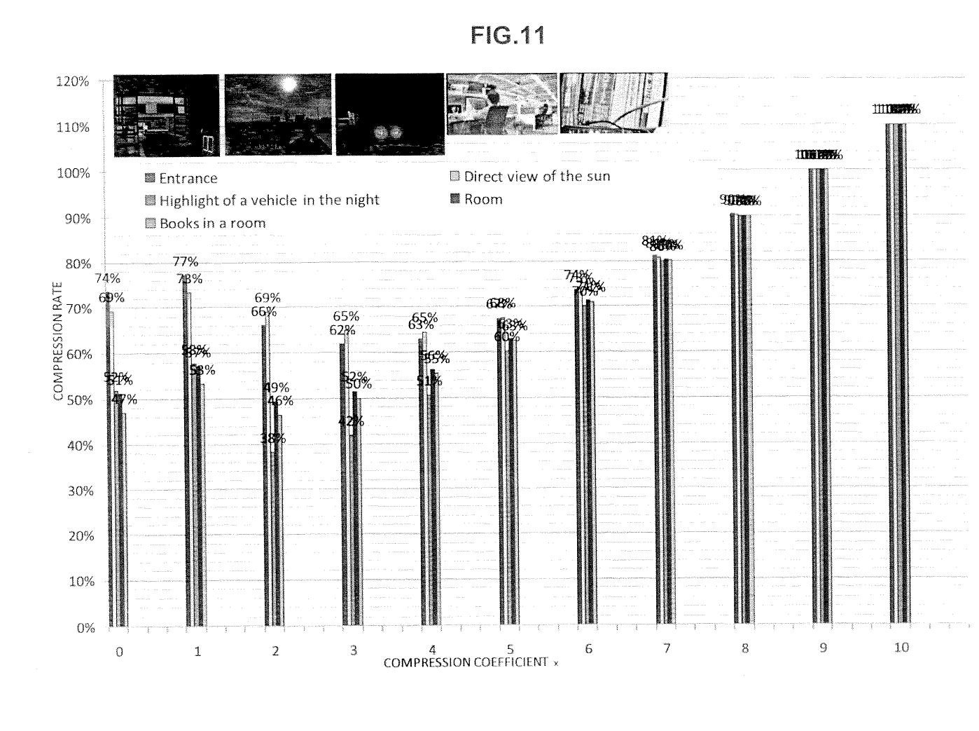

FIGS. 11 to 16 are graphs showing a compression example of the video signal before wide dynamic range combination. FIGS. 11 to 16 are compression examples of image data obtained by image-capturing five kinds of scenes, which are an entrance, a direct view of the sun, a highlight of a vehicle in the night, a room, and books in a room.

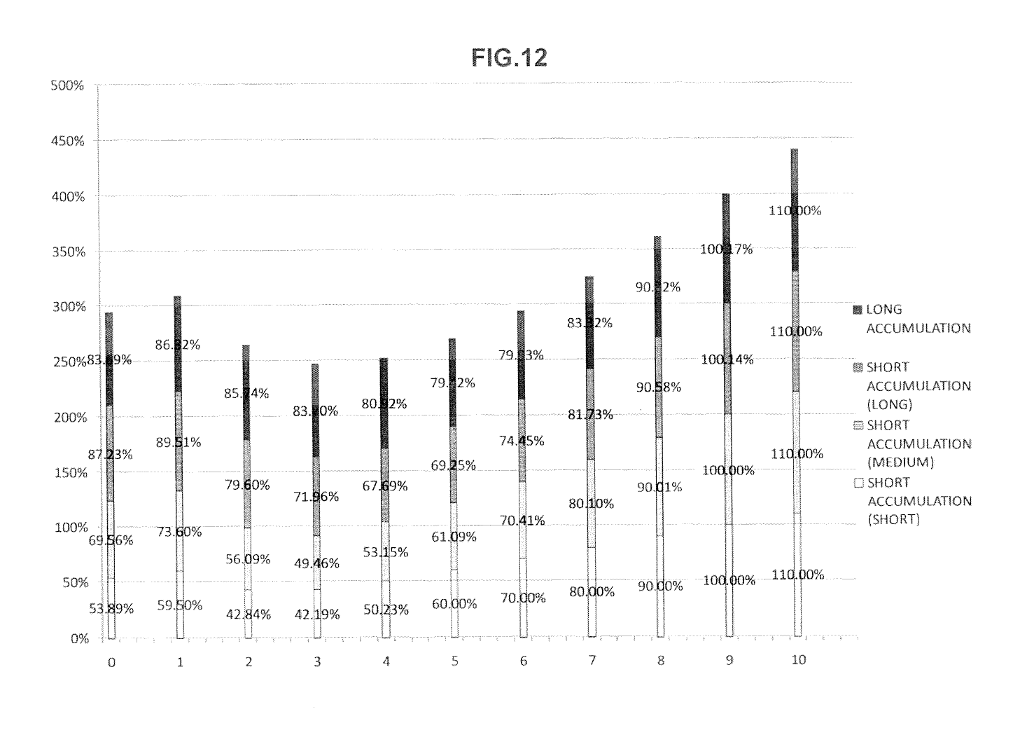

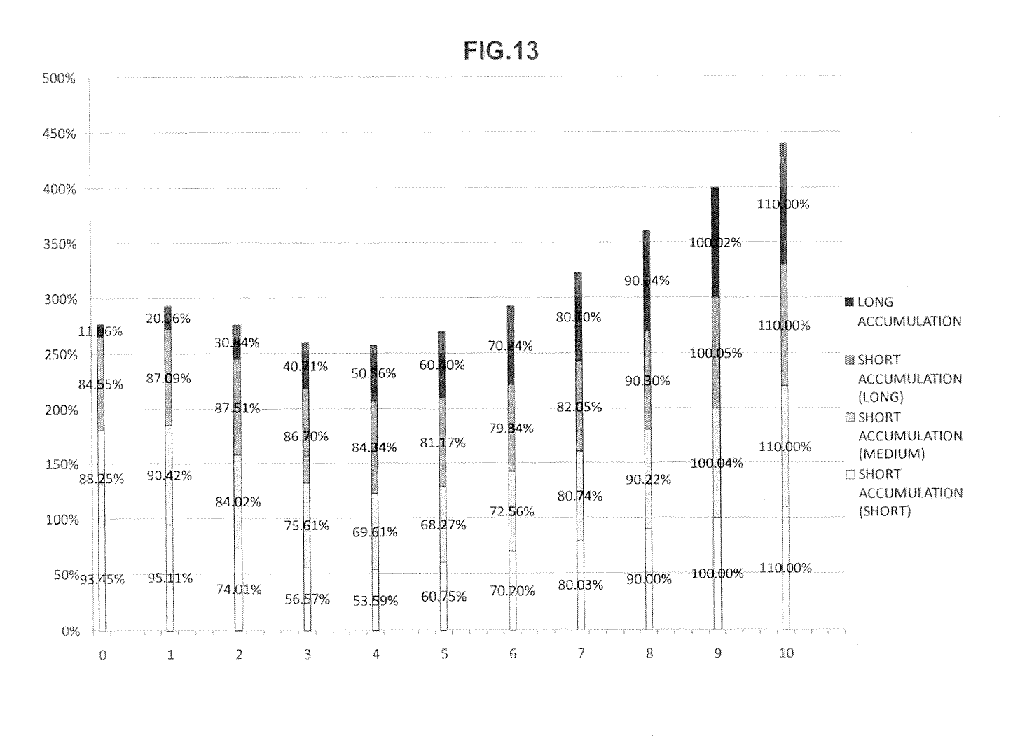

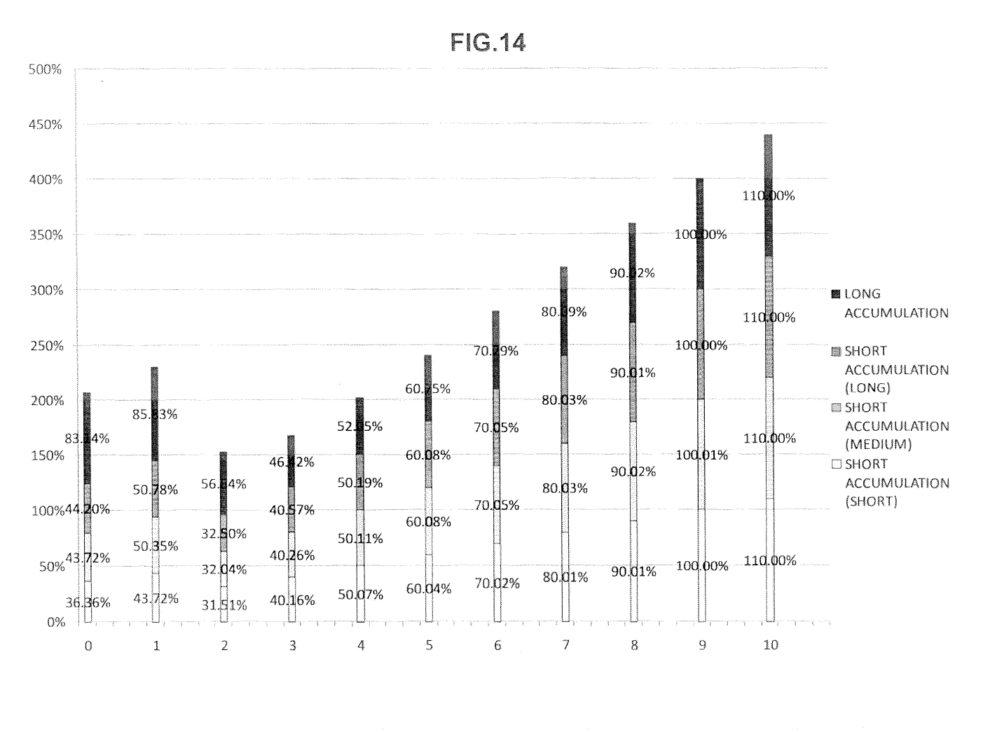

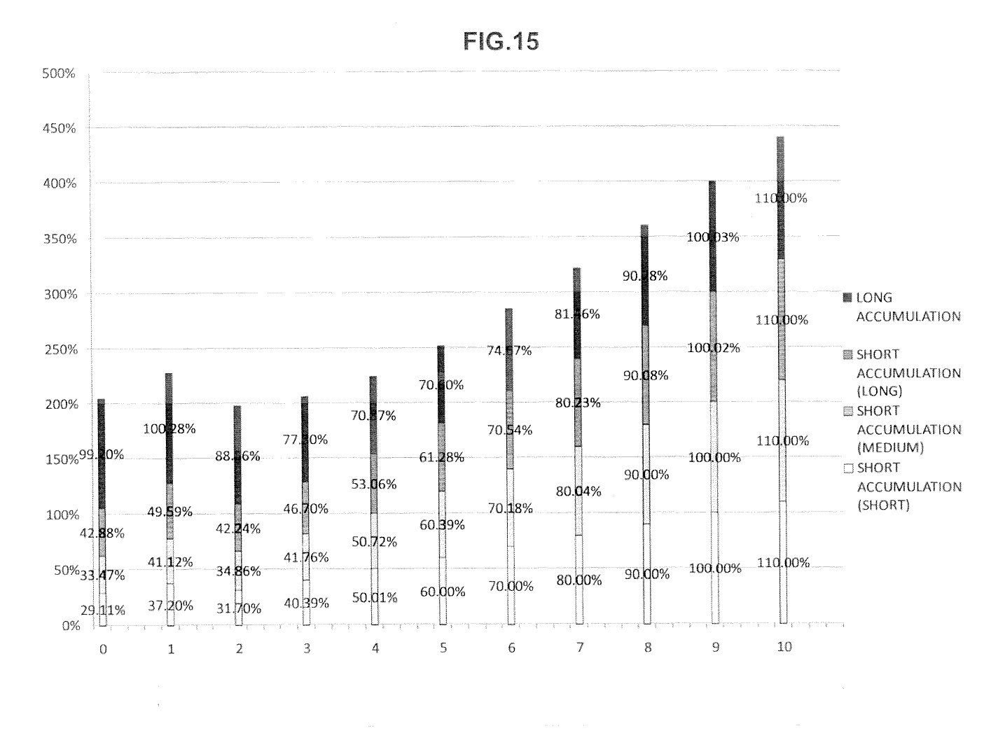

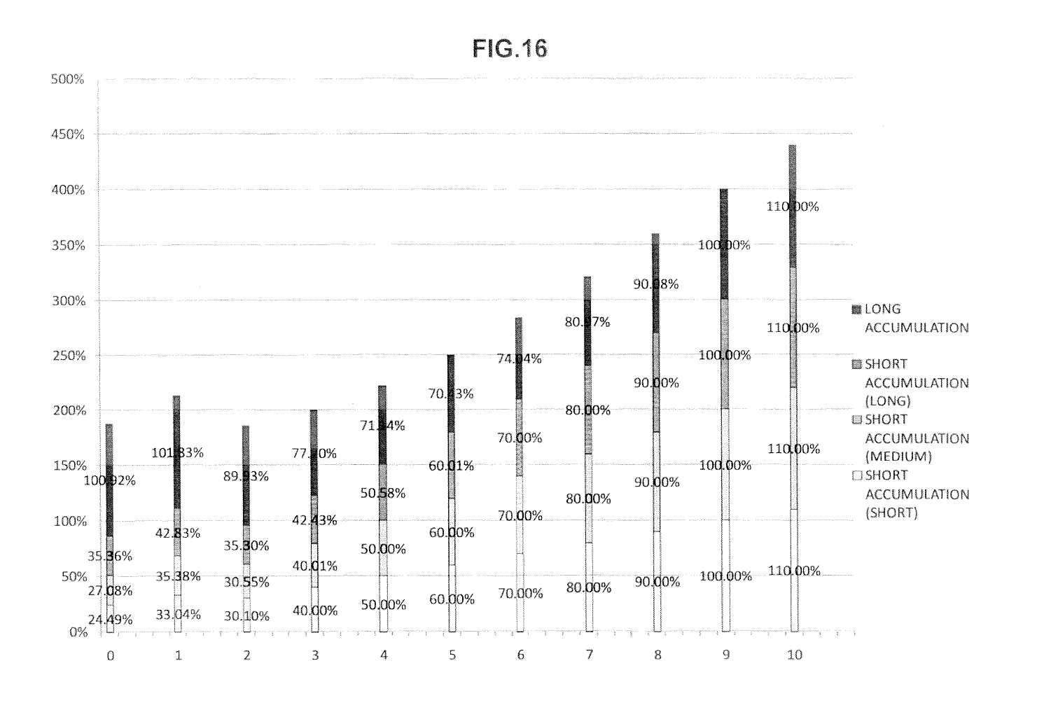

These are the results of calculations in which compression rates are calculated for compression coefficient x=0 to x=10 with respect to a video signal (the number of pixel bits n=10). FIG. 11 shows frame average values of each scene. FIG. 12 shows compression rates for each compression coefficient of a scene of an entrance, FIG. 13 shows those of a direct view of the sun, FIG. 14 shows those of a highlight of a vehicle in the night, FIG. 15 shows those of a book in a room, and FIG. 16 shows those of an outdoor book. In FIGS. 11 to 16, compression rates are shown for each exposure condition (long accumulation, short accumulation (long), short accumulation (medium), short accumulation (short)).

Although compression rate varies depending on a scene of image capturing and a compression coefficient, a compression rate of approximately 38% to 65% is realized in this embodiment even though this embodiment is a simple algorithm.

If a wide dynamic range video image is compressed and decompressed by the algorithm of this embodiment, an amount of use of memory bandwidth can be reduced when the video image is stored in a memory. In addition to the case in which the video image is stored in a memory, when the video image is outputted to an external bus to transmit the video image to another signal processing IC, an amount of use of bus bandwidth can be reduced.

Further, when a CPU or the like reads a wide dynamic range video image before combination stored in a memory of a device, if the video image is read while the video image is still compressed, a read time can be reduced. The compression processing of this embodiment is lossless compression, so that the video signal does not deteriorate. Furthermore, a simple algorithm is employed in this embodiment, so that compression and decompression can be performed in real time if the algorithm is implemented in hardware, and thus near real time transmission with little delay can be realized. In addition, also when using the algorithm of this embodiment in software, the load is small. The algorithm can be implemented in a small-scale LSI and FPGA. Although the algorithm is a simple algorithm having little effect on ordinary images, effective compression rate can be realized for wide dynamic range video image because the algorithm uses characteristics of wide dynamic range video image data.

Further, a certain level of scalable implementation of the algorithm is possible, in other words, the algorithm can be implemented in various scale circuits by using, for example, a fixed value compression coefficient in accordance with a scale of circuit that can be used.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-273819 filed in the Japan Patent Office on Dec. 1, 2009, the entire content of which is hereby incorporated by reference.

What is claimed is:

1. An image capturing device comprising:
a compression unit for lossless-compressing a video signal outputted from an imaging element;
a storage unit for accumulating the video signal that is compressed;
a decompression unit for decompressing the video signal that is compressed and accumulated in the storage unit; and
a combining unit for combining a plurality of frame images based on the decompressed video signal into one frame image.

2. The image capturing device according to claim 1,
wherein the compression unit lossless-compresses the video signal that is outputted from the imaging element and has not been lossy-compressed yet.

3. The image capturing device according to claim 1,
wherein the compression unit lossless-compresses the video signal on the basis of difference information between a pixel value of a pixel of interest and a pixel value of another pixel in the video signal and the number of bits that represent the difference information.

4. The image capturing device according to claim 1,
wherein the number of the decompression units is the same as the number of a plurality of frame images that are combined by the combining unit.

5. An image capturing device comprising:
a compression unit for lossless-compressing a video signal which is outputted from an imaging element and in which a plurality of frame images are combined into one frame image;
a storage unit for accumulating the video signal that is compressed; and
a decompression unit for decompressing the video signal that is compressed and accumulated in the storage unit and outputting the decompressed video signal to an image processing unit for image-processing a current video signal.

6. The image capturing device according to claim 5,
wherein the compression unit lossless-compresses the video signal that is outputted from the imaging element and has not been lossy-compressed yet.

7. The image capturing device according to claim 5,
wherein the video signal that is compressed by the compression unit is floating-point format.

8. The image capturing device according to claim 7,
wherein the compression unit divides the floating-point format video signal into an exponent part and a mantissa part and compresses the exponent part and the mantissa part individually.

9. The image capturing device according to claim 8,
wherein the compression unit lossless-compresses the video signal on the basis of comparison information between an exponent part of a pixel value of a pixel of interest and an exponent part of a pixel value of another pixel in the video signal and the number of bits that represent an exponent part of the pixel value of the pixel of interest.

10. The image capturing device according to claim 8,
wherein the compression unit lossless-compresses the video signal on the basis of difference information between a mantissa part of a pixel value of a pixel of interest and a mantissa part of a pixel value of another pixel in the video signal and the number of bits that represent the difference information.

11. An image capturing method, comprising the steps of:
lossless-compressing a video signal outputted from an imaging element by using a compression unit;
accumulating the compressed video signal by using a storage unit;
decompressing the video signal that is compressed and accumulated in the storage unit by using a decompression unit; and
combining a plurality of frame images based on the decompressed video signal into one frame image by using a combining unit.

12. An image capturing method, comprising the steps of:
lossless-compressing a video signal which is outputted from an imaging element and in which a plurality of frame images are combined into one frame image by using a compression unit;
accumulating the compressed video signal by using a storage unit; and
decompressing the video signal that is compressed and accumulated in the storage unit and outputting the decompressed video signal to an image processing unit for image-processing a current video signal by using a decompression unit.
